(19) United States
(12) Patent Application Publication
(10) Pub. No.: US 2006/0141919 A1
(43) Pub. Date: Jun. 29, 2006

(54) SUPER POKER CAROUSEL

(76) Inventor: Christian Storinggaard, Hoersholm (DK)

Correspondence Address: LOUIS VENTRE, JR, 2483 OAKTON HILLS DRIVE, OAKTON, VA, 22124-1530, US

(21) Appl. No.: 10/905,274

(22) Filed: Dec. 23, 2004

(51) Int. Cl. G07D 9/06

(52) U.S. Cl. 453/61

(57) ABSTRACT

An improved poker chip storage device, and method for using same, that combines a traditional poker chip storage device with an accessible money box and a convenient means for inserting the money in the money box.

The invention is an improved poker chip storage device that combines a traditional poker chip storage device with a money box and a convenient means for inserting the money in the money box.

### BACKGROUND OF THE INVENTION

Poker chip storage devices have been in commercial use for well over a century. Typical is U.S. Pat. No. 617,478, issued in 1899 to Stanley A. Cohen of New York, which describes right circular cylindrical combination carrier body provided with chip receiving pockets and movable chip support to enable dropping all the chips in a stack to the table. As with many such chip storage devices, this device also has storage recesses for decks of cards.

Another is U.S. Pat. No. 3,525,442 issued in 1969 to William H. Aincham of Bensenville, Ill. This improved chip holder added a top plate and peripheral posts to secure the chips in a star-shaped carrier body to prevent accidental spills. It also had a means for “snuggly gripping” two decks of cards between posts at the top.

These two patents are representative of existing poker chip holders, whether rotating or non-rotating. While existing poker chip holders typically provided storage for playing cards and poker chips, for over 100 years they have not included a means to secure money, which typically would be exchanged for chips.

An important object of this invention is to provide a poker chip holder that also permits a fast, simple and secure means for storing money.

### BRIEF DESCTRIPTION OF THE DRAWINGS

FIG. 1 shows a single tier super poker carousel with a slot, ram device and money box.

FIG. 2 shows a double tier super poker carousel with a slot, ram device and money box.

### DETAILED DESCRIPTION OF THE INVENTION

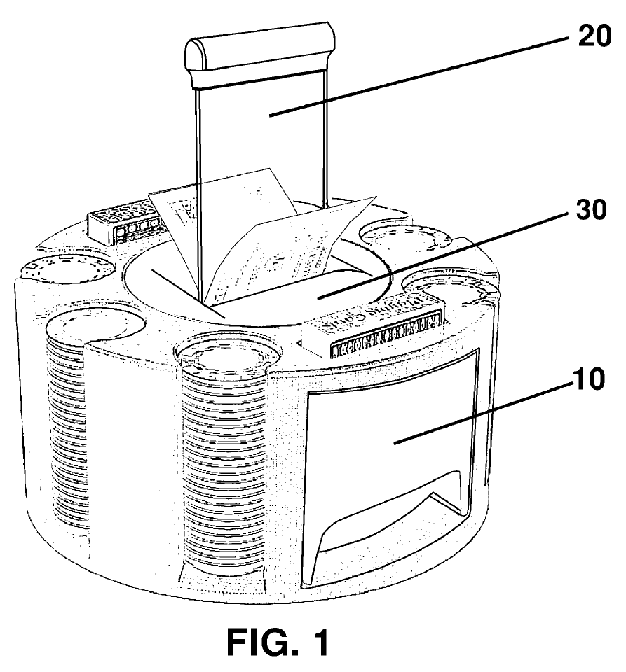

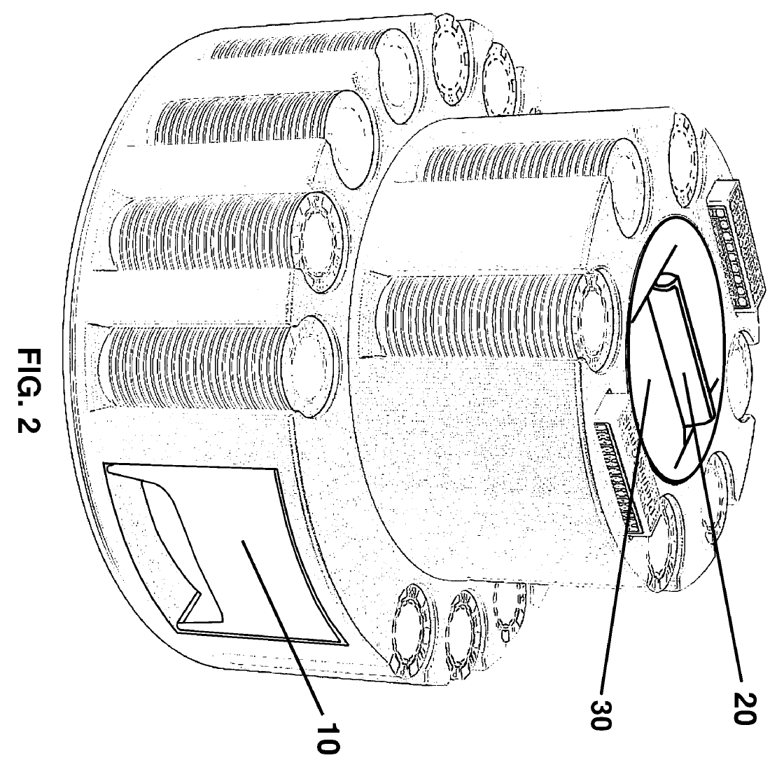

An apparatus termed a “super poker carousel,” and a process for using the apparatus. FIG. 1 and FIG. 2 describe typical poker chip storage devices. While the preferred embodiment of the invention utilizes one or more right circular cylindrical poker chip storage devices, any shape poker chip storage device capable of containing an accessible money box is also within the intended scope of the invention.

The super poker carousel is an improved poker chip storage device that combines any typical poker chip storage device, one such type is as shown in the figures, with a top (30) providing slotted access to an internal, an accessible money box (10), and a ram device (20) for inserting the money into the money box. In the preferred embodiment, the money box may also be thought of as a drawer fitted into the super poker carousel. Such a drawer is not essential to the invention. The important feature is that the money box is contained within the poker chip storage device. In an alternative embodiment, the money box may be accessed and or removed by opening or detaching a door in the body of the poker chip storage device.

In the preferred embodiment, the money box is a sliding box or receptacle opened by pulling out from the poker chip storage device and closed by pushing into the poker chip storage device. The money box optionally includes a lock to prevent unauthorized accessibility to its contents.

Flexibility in how the money box is contained within the poker chip storage device coupled with flexibility in how the money box is accessed, permits the invention to be adapted to a wide variety of shapes for poker chip storage device.

FIG. 1 shows the ram device (20) partially inserted in the poker chip storage device in the process of inserting paper money. FIG. 2 shows the ram device (20) fully engaged in the slot.

In the method of the invention, the money box starts out fully contained within the body of the poker chip storage device. Paper money is laid across the slot in the top (30) of a poker chip storage device. Then the ram device (20) engages the money when the ram device is inserted into the slot. The ram device is pushed to the bottom of the poker chip storage device where it deposits the money in the money box. The ram device may then either rest in place or be removed, typically removal would be incident to inserting more money in the slot. Coinage is dropped into the slot once the ram device is removed. When access to the money is sought, the money box is slid from the poker chip storage device, or, in the case of alternative embodiments, removed by opening an access door.

In an alternative method, one may start by wrapping paper money around the ram device; then inserting the ram device with the money fully into the slot in the top of the poker chip storage device. This will then deposit the money in the money box.

The money box may be equipped with a means for assisting in its removal from the poker chip storage device. Such means typically include molded recessed contour, as shown in FIG. 1 and FIG. 2 to provide finger access to assist in slidably removing it from the super poker carousel body, a pull tab of the kind typically used on drawers, a push-release spring device commonly used on cabinet doors, or such other similar devices well known in the art of cabinetry.

While there has been described herein what is considered to be the preferred exemplary embodiments of the present invention, other modifications of the present invention shall be apparent to those skilled in the art from the teachings herein, and it is, therefore, desired to be secured in the appended claim all such modifications as fall the true spirit and scope of the invention. Accordingly, what is desired to be secured by Letters Patent of the United States the invention as defined and differentiated in the following claims in which

What is claimed is:

1. An improved poker chip storage device comprising, an accessible money box; a top providing slotted access to said money box; and a ram device for inserting the money into said money box.

2. The poker chip storage device of claim 1 further comprising a lock on said money box.

3. The poker chip storage device of claim 1 wherein the money box is a drawer.

4. The poker chip storage device of claim 3 further comprising a means for assisting in removal of said money box from its storage position within said poker chip storage device.

5. The poker chip storage device of claim 4 wherein said means fro assisting in removal of said money box is a molded front providing finger access to assist in removing said money box from said storage device.

6. The poker chip storage device of claim 1 wherein the money box is made accessible by a door on the poker chip storage device.

7. A method of using the poker chip storage device of claim 1 comprising the steps of, laying paper money across the slot in the top of said poker chip storage device; engaging the ram device with the money, wherein the ram device is fully inserted into the slot to deposit the money in said money box.

8. A method of using the poker chip storage device of claim 1 comprising the steps of, removing the ram device from said poker chip storage device; and, inserting coinage into the slot.

9. A method of using the poker chip storage device of claim 1 comprising the steps of, wrapping paper money around said ram device; inserting said ram device with the money fully into the slot in the top of said poker chip storage device.
